(19) United States
(12) Patent Application Publication
(10) Pub. No.: US 2009/0143981 A1
(43) Pub. Date: Jun. 4, 2009

(54) Method and system for setting the destination of a navigation system based on the message recorded in an electronic document

(76) Inventor: Chun-Huang Lee, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,683

(22) Filed: Dec. 4, 2007

(51) Int. Cl. G01C 21/30; G01C 21/20

(52) U.S. Cl. 701/209; 701/207

(57) ABSTRACT

A method and system for setting the destination of a navigation system based on the message recorded in an electronic document is provided. This system transforms an address recorded in an electronic document into positioning data, which is recognizable to a navigation system, by means of a software application. Particularly, the electronic document is provided by an electronic document module, which includes electronic mail, mobile phone messages, web pages and an electronic maps. Those kinds of electronic documents may have address information with a specific format. The software application transforms the address information into the recognizable positioning data and sets a destination. After that, the system calculates a navigation route according to the destination.

### BACKGROUND OF THE INVENTION

1. Field of the Invention

The present invention relates to a method and a system for setting the destination of a vehicle navigation system based on the message recorded in an electronic document, and more particularly to automatically set the navigation destination according to positioning data obtained from address information contained in the electronic document.

2. Description of Related Art

When a navigation system is used, users first need to set a start position by pointing to a touch screen or inputting an address, and then set a destination. Afterward, the navigation system calculates the navigation route by means of an algorithm.

Besides the textual destination input method, U.S. Pat. No. 6,430,500 published on Aug. 6, 2002 disclosed a destination input device in a vehicle navigation system that can set the current position and the destination through a touch panel in one of its embodiments. Furthermore, the destination can be set by means of interaction between a voice recognition system and the navigation system.

Because users often need to enter a destination into the navigation system during travel, one system of the prior art aims at accelerating the input speed by generating selectable destinations as a function of the distances of the destinations to the current location. Reference is made to a method for inputting the destination disclosed in U.S. Pat. No. 6,947,834 that was published on Sep. 20, 2005.

Furthermore, U.S. Pat. No. 7,239,961, published on Jul. 3, 2007, disclosed a method for inputting destination data through a mobile terminal, which is different from the conventional method for inputting the destination via an input device of the prior art. Reference is made to FIG. 1. The mobile terminal 10 such as a Personal Digital assistant (PDA) or a mobile phone of the prior art connects to a navigation system 12 by means of a wireless connection. Thereby, the mobile terminal device 10 has an address database 101 and a short range wireless interface brought into contact with the navigation system. After a user selects an input function through a user interface (UI) 105, a wireless communication module 103 and the wireless communication module 121 of the navigation system 12 transmit the positioning data by means of the short range communication. The configuration of the navigation destination is done after compilation of the data. After that, the address information such as the address book stored in the mobile terminal 10 is transmitted to the navigation system 12. This implementation provides a method for entering address information into the navigation system that is different from the manual methods the other technologies provide.

### SUMMARY OF THE DISCLOSURE

The present invention avoids the drawbacks of prior navigation systems arising from the need to manually input the start and destination addresses, or from the need to select the destination from a database. Instead, the present invention provides a method and a system for setting the navigation destination based on the message in an electronic document.

An address record on electronic documents such as electronic mail, messages sent via mobile phone, messages on a web page, or indications on a map, is transmitted to the navigation system directly. After that, a set of longitude and latitude coordinates are computed from the address, so as to set the navigation destination.

In a preferred embodiment, the method for directly setting a position in a navigation system based on address information in an electronic document is to provide an electronic document from an electronic document module firstly. The electronic document can be an electronic mail, a message sent via mobile phone, a message on a web page, or an electronic map. The method is to generate destination information automatically or manually by a user's click action, and a navigation program is activated subsequently. After that, software transforms the destination information into positioning data which is recognizable by the navigation system. Then the navigation program sets the destination and calculates a navigation route according to the positioning data.

The system for setting the destination of a navigation system of the present invention mainly includes three functional modules—an electronic document module for receiving and browsing an electronic document such as an electronic mail, a mobile phone message, a web page or an electronic map, a navigation module used to set a navigation destination and to calculate a navigation route based on address information generated by the electronic document module, and a software module used to transform the address information into recognizable positioning data, and provide the positioning data to the navigation module for calculating the navigation route.

### BRIEF DESCRIPTION OF DRAWINGS

The present invention will be readily understood by the following detailed description in conjunction accompanying drawings, in which:

FIG. 1 shows a schematic diagram of setting navigation destination of the prior art;

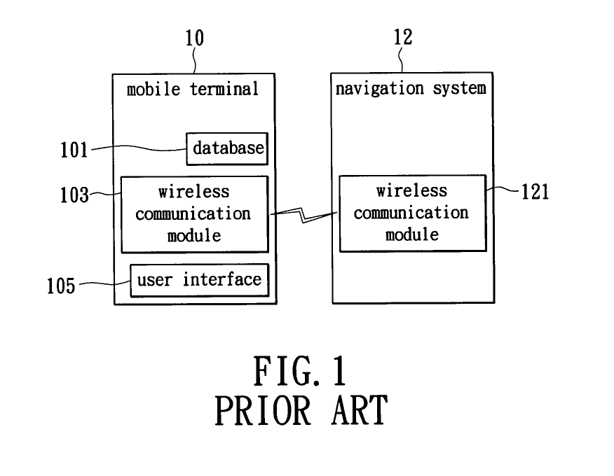

FIG. 2 shows a schematic diagram of an electronic document of an embodiment of the present invention;

FIG. 3 shows a systematic structure of the present invention;

FIG. 4 shows the system for setting navigation destination based on the electronic document of the embodiments of the present invention;

FIG. 5 shows the system for setting navigation destination based on the electronic document of the embodiments of the present invention;

FIG. 6 shows the system for setting navigation destination based on the electronic document of the embodiments of the present invention;

FIG. 7 shows the system for setting navigation destination based on the electronic document of the embodiments of the present invention;

FIG. 8 is a flow chart of the method for setting the navigation destination based on the electronic document of the present invention.

### DETAILED DESCRIPTION OF THE PREFERRED EMBODIMENTS

To understand the technology, means and functions adopted in the present invention further, references are made to the following detailed description and attached drawings. The invention shall be readily understood deeply and concretely from the purpose, characteristics and specification. Nevertheless, the present invention is not limited to the attached drawings and embodiments in following description.

The present invention relates to a method and a system for setting the destination of a navigation system based on an electronic document. The invention features that a destination can be set directly by a navigation system based on the address information included in the electronic document, and the electronic document is received by a specific device. By means of a graphic interface and a method for automatically setting destination, the conventional steps for setting the destination can be simplified.

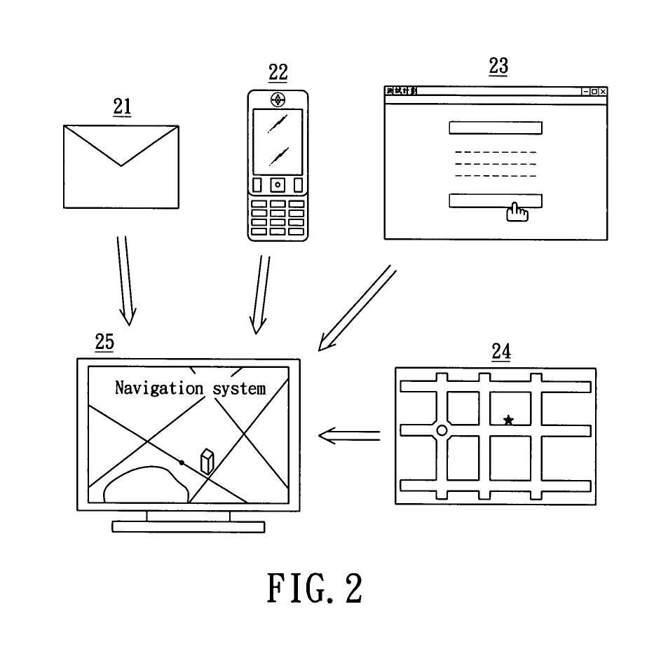

Reference is made to FIG. 2 showing a schematic diagram of types of the electronic documents in an embodiment of the present invention. A navigation system 25 electrically connects with kinds of electronic documents capable of recording the destination information. For example, the address information can be a regular mailing address, landmark, longitude/altitude, or indication on map. The system and its method of the present invention can transform the address information recorded in the every kind of electronic documents into a required format for setting the destination in the navigation system, and directly set thereto.

In an exemplary embodiment, the electronic mail 21 received by an electronic system such as the mobile communication device including a desktop computer, laptop, PDA, and mobile phone. Via the electronic mail 21, the messages for activity advertisement or appointment location can be delivered. The content of the electronic mail 21 may include the address information, and the address information can be transformed into address, indication on a map, or a set of longitude and altitude which are transmitted to the navigation system 25 for further configuration. Since the address information can be used for configuring the navigation system, some complex steps for manually entering the address or setting the destination by other means can be saved. In the preferred embodiment of the present invention, the system for receiving the electronic mail 21 can be integrated with the navigation system 25, and thereby the address information in the electronic mail 21 can be transformed into the required information for the navigation system 25 conveniently by means of software. Further, the system of electronic mail 21 and the navigation system 25 are two separate devices in one embodiment, but can be electrically combined thereto for delivering message.

In another exemplary embodiment, the mobile phone message 22 can be used for delivering activity information through the mobile phone, and the required address information for the navigation system 25 is included in the mobile phone message 22. After that, the address, map or information having longitude and latitude recorded in the mobile phone message 22 can be transferred to the navigation system 25 for configuration. Preferably, the navigation system 25 might be embedded in the mobile phone, and a software program therein is conveniently and rapidly used to configure the destination or the related content as receiving the mobile phone message 22.

In a further embodiment of using the content provided in a web page 23, wherein the address information including an address, indication on map or the message having longitude and altitude can be extracted. When a user browses the activity information, appointment location or the related advertisement recorded on the web page 23, the recorded content can be easily transferred to the navigation system 25.

An electronic map 24 implements another type of the electronic document, and the map 24 can be obtained by above-mentioned, but not limited to, methods including the electronic mail, mobile phone message and the content on the web page. The map 24 can clearly present the address information, and electrically connect with the navigation system 25 through a specific device. By means of the software application, the user can set the destination location in the navigation system 25 by clicking on the electronic map 24.

Such as the above-mentioned embodiment, the system provided by the present invention can obtain the accurate destination information through every kind of position information recorded in the electronic documents but is not limited thereto. The positioning method is either not limited to on positioning data, but able to set a plurality of positions successively before reaching the destination. Therefore, a complete navigation route is achieved. Particularly, the content of the mentioned electronic documents, such as the electronic mail 21, mobile phone message 22, web page 23 or the map 24, are edited in compliance with a format supported by the navigation system 25 or a conventional industrial standard. The formatted content can be effectively combined with the navigation system 25 since the address information included in the content is in compliance with the specific format or standard. In the embodiments, a special button, or a software-implemented button shown on the electronic document can be executed to transfer the destination information.

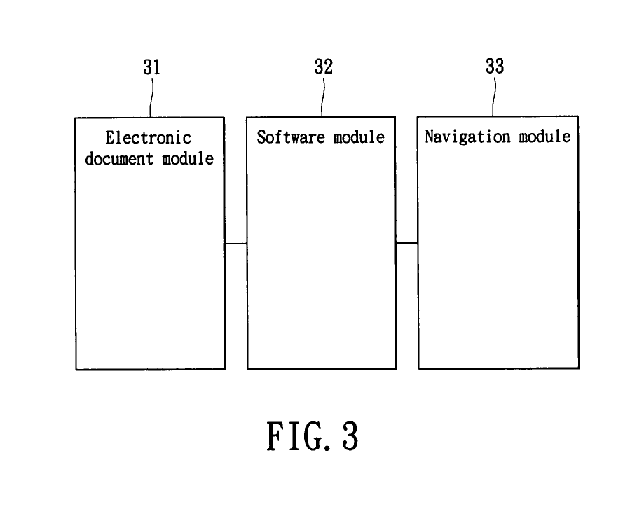

According to schematic diagram of a systematic structure shown in FIG. 3, the system for setting the navigation destination based on the electronic document includes three major functional modules. One of the functional modules is an electronic document module 31 for receiving and browsing the electronic document. The electronic document module 31 has the functions including an electronic mail agent program for receiving the electronic mail, and a mobile phone module for receiving the mobile phone message, and a web page browsing program for browsing the web pages, and a browsing program for running through the electronic map.

The other functional module is a navigation module 33. The navigation module 33 sets a navigation destination according to the address information produced by the electronic document module 31, and calculates the cruising route. Further, the navigation module 33 outputs the navigation message, including a vocal or screen-displayed message, though an output interface. The address information produced by the electronic document module 31 is transformed into a system-recognizable positioning data by a software module 32. Next, the positioning data is transferred to the navigation system 33 for scheduling the navigation route.

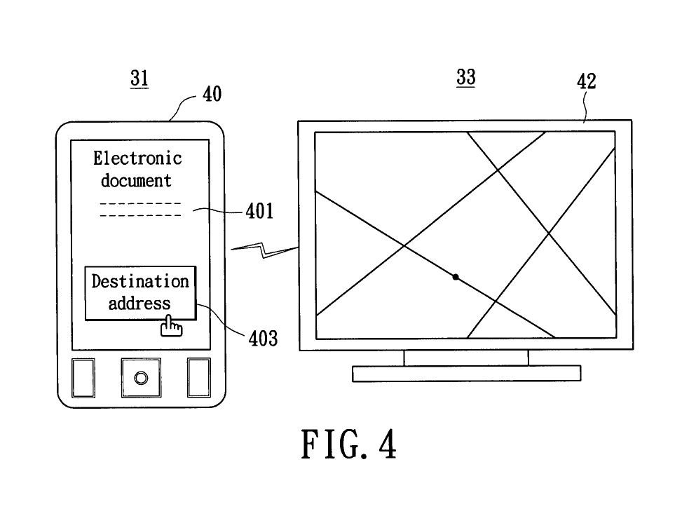

Reference is made to FIG. 4, which shows a system for setting the navigation destination based on the message in the electronic document. The navigation module 33 and the electronic document module 31 capable of browsing and receiving the electronic document are two separate devices in this embodiment. In an exemplary embodiment, a mobile communication device 40 connects with the navigation module 33 by means of wireless connection. An electronic document 401, such as the electronic mail, mobile phone message, web page, electronic map or the like, is shown on the mobile communication device 40. Besides the address information on the electronic document 401 can be automatically transformed into the required format for the navigation module 33 through the software program, a user can use an execution button 403 to execute a background program to transform the address information. The execution button 403 is on the electronic document 401 and implemented by a software program. Through the communication method implemented between the mobile communication device 40 and the navigation module 33, the address information of the electronic document module 31 is submitted to the navigation module 33. More, the related configurations are automatically executed. Please refer to the map and its indications shown on screen 42 of the figure.

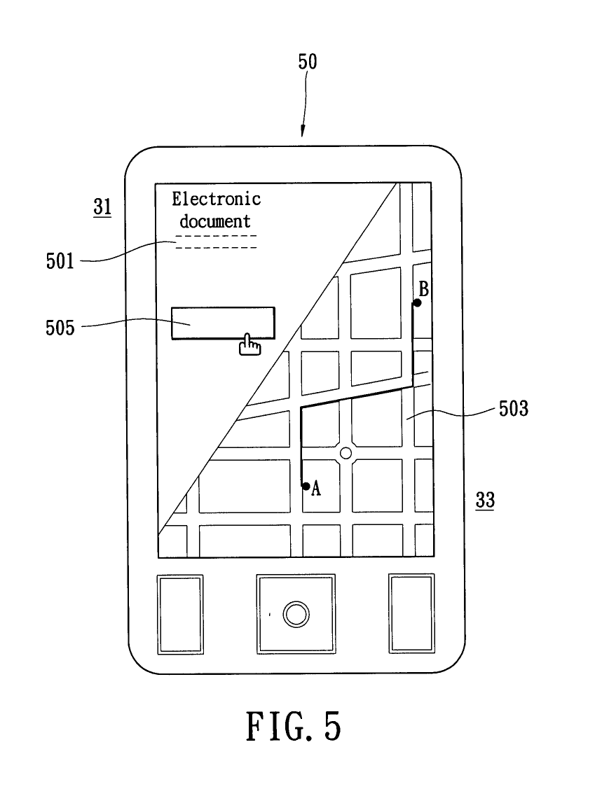

FIG. 5 shows another embodiment of the system for setting the destination. Therein the navigation 33 and the electronic document module 31 are combined into an electronic system 50 capable of browsing and receiving the electronic document. The electronic system is a mobile communication device such as a personal digital assistant (PDA) or mobile phone. More, the electronic system can combine the applications provided by the navigation module 33 and the other systems. More, the electronic system equips the relevant software or hardware with the navigation module 33—including an antenna, navigation system and the map.

The two applications having the electronic document module 31 and the navigation module 33 in this embodiment are shown in the figure. One of the applications is a software application used for displaying, browsing and receiving an electronic document 501, and the electronic document includes the mentioned electronic mail, mobile phone message, web page, or electronic map. The other one of the applications is a navigation program for a navigation map 503. When the program browses the electronic document 501, the address information therein is transferred to the navigation program by means of software. For example, an execution button 505 is used, thereby to submit the address information through a background program. Next, the address information is transformed into a recognizable message for the navigation program. After that, the navigation address is configured, such as the destination B shown in the diagram. Furthermore, the navigation route from a starting point A to destination B is calculated.

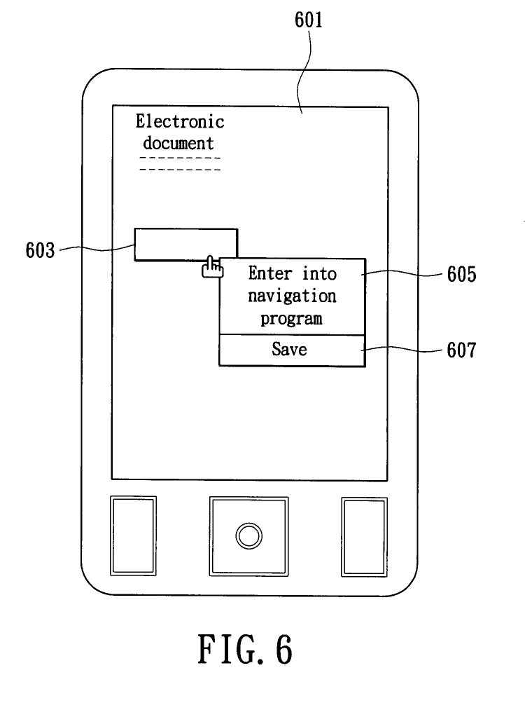

The system for setting the navigation destination of another embodiment of the present invention is shown in FIG. 6, which describes an apparatus of combining the electronic document module and the navigation module. Address information 603 is recorded in an electronic document 601 that is displayed on a screen of the apparatus with navigation function. In an exemplary embodiment, at least two function selections, such as a drop down list window or a first selection 605 and a second selection 607 shown on the figure, are provided by the electronic document module when a user clicks on the address information 603. After that, the address information 603 can be saved into memory if the user makes the second selection 607 through the graphic interface. The address information 603 can also be established in a database that implements the address used for setting the navigation destination later. On the other hand, a program of the navigation module in the first selection 605 is introduced to transform the address information into positioning data for directly setting the navigation destination.

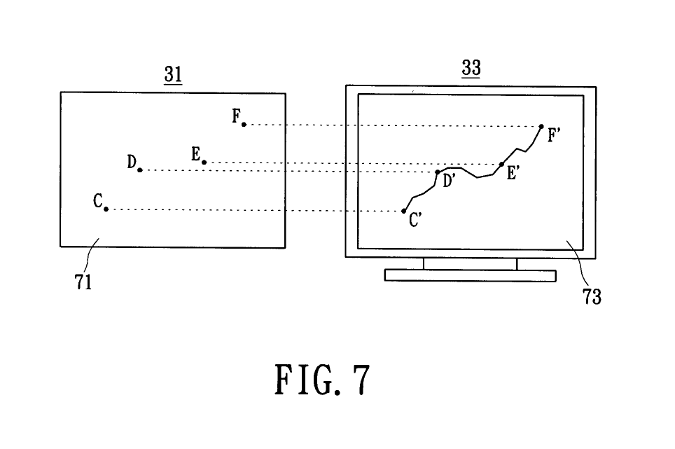

FIG. 7 shows another embodiment of, the system for setting the navigation destination. Therein an electronic document module 31 positions the navigation destination through an indication on an electronic map 71. One or a plurality of locations recorded on the electronic map 71 can be selected through a graphic interface as the module 31 receives the electronic map 71. For example, the plurality of positions can be indicated on the map in advance as traveling, and those positions are transmitted to the navigation module 33 by a software module. Then all the positions with corresponding indications are marked on the map of the navigation module 33. Next, the corresponding map with the marks is shown on the screen 73 of the navigation module 33, and the navigation routes are calculated accordingly.

Since a first position C is selected, the address information regarding the first position C is transformed into positioning data through the software application. Next, the navigation module 33 sets a first navigation position such as the first navigation position C′ shown on the screen 73. Next, a second position D on the electronic map 71 is selected, and the address information thereof is transformed into the second navigation position D′ shown on the screen 73. After that, the route between the first navigation position C′ and the second position D′ is calculated. Next, a third position E on the map 73 is selected, and its address information is transformed into the third navigation position E′ shown on the screen 73. After that, the route from the second navigation position D′ to the third navigation position E′ is calculated. At last, a fourth position F on the map 71 is selected, and its address information is transformed into the fourth navigation position F′. The route from the third navigation position E′ to the fourth navigation position F′ is again calculated alike.

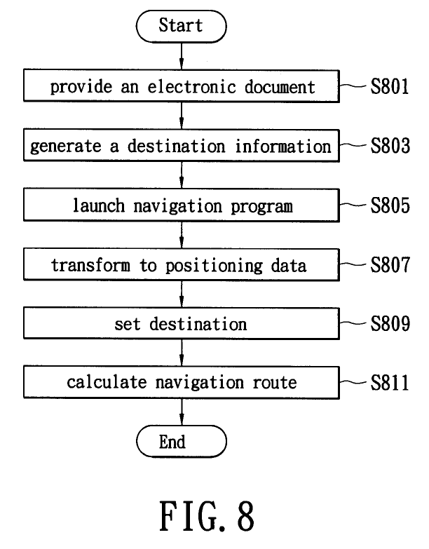

To conclude the features described in above-mentioned embodiments, reference is made to FIG. 8 showing a flow for the method for setting the navigation destination based on the message on an electronic document. In particular, a software application is used to transform the address information recorded in the electronic document module into the positioning data in the navigation module. In the beginning, the electronic document module provides an electronic document (step S801). This electronic document can be implemented as a received electronic mail, a mobile phone message sent from a mobile phone, the content on a web page or a received electronic map. The content recorded in the electronic document has address information with a specific form, that includes a mailing address, landmark or information having longitude and altitude. Next, the address information of a destination is generated from the electronic document automatically, or the address information is generated through a manual selection responsive to a user's click action (step S803). Next step is to launch a navigation program (step S805). Since the mentioned address information includes some data types with specific format, the software application in compliance with one of the types is launched. In the present embodiment, the navigation program in compliance with a mailing address is executed.

Next, by means of the navigation program, the mentioned address information is transformed into a recognizable positioning data that is in accordance with a format provided by the navigation program or an industrial standard (step S807). In an exemplary embodiment of the invention, a software-made button is used to execute a background program, and transmit destination information. Next, the destination information is transformed into a value with longitude and altitude by means of software. The value is transmitted to the navigation program, and thereby to set a destination by inputting the positioning data to the navigation program (step S809). Consequently, a navigation route is calculated according to positioning data and a navigation algorithm (step S811).

In summation of the description above, the method and system for setting the navigation destination are implemented to recognize the positioning data transformed from a record in the electronic document by means of software. The recognizable positioning data is used for set the navigation destination, thereby to simplify the configuration interface instead of the conventional complex steps.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for setting the destination of a navigation system based on the message recorded in an electronic document, comprising:
providing an electronic document containing address information;
generating destination information with corresponding address information;
activating a navigation program;
transforming the destination information into positioning data; and
inputting the positioning data to the navigation program for destination setting.

2. The method of claim 1, wherein the step of transforming the destination information into the positioning data is performed by a software application.

3. The method of claim 1, wherein the destination information is automatically generated from the electronic document.

4. The method of claim 1, wherein the destination information is generated manually by user's click action.

5. The method of claim 1, wherein the step of transforming the destination information into positioning data employs a software button to execute a background program for sending out the destination information, and then to transform the information into a set of longitude and latitude by a software application.

6. The method of claim 1, wherein the electronic document is an electronic mail.

7. The method of claim 1, wherein the electronic document is a message sent from a mobile phone.

8. The method of claim 1, wherein the electronic document is a web page.

9. The method of claim 1, wherein the electronic document is an electronic map.

10. A system for setting the destination of a navigation system based on an electronic document, comprising:
an electronic document module that provides an electronic document;
a navigation module used to set a navigation destination based on address information generated by the electronic document module, and thereby to calculate a navigation route; and
a software module used to transform the address information into positioning data, and send the positioning data to the navigation module, to calculate the navigation route.

11. The system of claim 10, wherein the navigation module and the electronic document module are two separate devices that are interconnected by means of wireless communication.

12. The system of claim 10, wherein the navigation module and the electronic document module are integrated into an electronic system.

13. The system of claim 12, wherein the electronic system at least includes a program to browse and receive the electronic document, and another program to operate navigation.

14. The system of claim 10, wherein the software module uses a software button to execute a background program, and send the address information recorded in the electronic document module to the navigation module.

15. The system of claim 10, wherein the electronic document module provides means for storing the address information, and means for interfacing the navigation module.

16. The system of claim 10, wherein the electronic document is an electronic mail.

17. The method of claim 10, wherein the electronic document is a message sent from a mobile phone.

18. The method of claim 10, wherein the electronic document is a web page.

19. The method of claim 10, wherein the electronic document is an electronic map.

20. The system of claim 19, wherein the electronic map includes a plurality of indicated positions that are sent to the navigation module by the software module.

21. The system of claim 20, wherein the positions are simultaneously indicated on the map of the navigation module, and the navigation routes among the positions are calculated.
